(19) United States
(12) Patent Application Publication
(10) Pub. No.: US 2009/0316581 A1
(43) Pub. Date: Dec. 24, 2009

(54) Methods, Systems and Computer Program Products for Dynamic Selection and Switching of TCP Congestion Control Algorithms Over a TCP Connection

(75) Inventors: Vivek Kashyap, Beaverton, OR (US); Sridhar Samudrala, Beaverton, OR (US); David L. Stevens, JR., Hillsboro, OR (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/144,975

(22) Filed: Jun. 24, 2008

(51) Int. Cl. G08C 15/00

(52) U.S. Cl. 370/236

(57) ABSTRACT

Methods, systems and computer program products for dynamic selection and switching of TCP congestion control algorithms over a TCP connection. Exemplary embodiments include a TCP congestion control algorithm management method, including establishing a first TCP connection on a first network having an end point, wherein the TCP connection includes a first TCP congestion control algorithm, monitoring path characteristics of the TCP connection and dynamically selecting and switching to a second TCP congestion control algorithm in a response to a change in the path characteristics of the TCP connection.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to TCP congestion control algorithms, and particularly to methods, systems and computer program products for dynamic selection and switching of TCP congestion control algorithms over a TCP connection.

2. Description of Background

TCP is one of the core protocols of the Internet Protocol Suite. TCP provides reliable, in-order delivery of a stream of bytes making it suitable for a wide range of applications, like file transfer, email, world-wide web, secure shell, etc. One important aspect of TCP is congestion control, which is a mechanism that is used to control the rate of data entering the network and keeping the data flow below a rate that would trigger congestion collapse. The primary function of TCP congestion control is to maintain the right size of the TCP window for efficient transmission. The tricky part is to find that right size. Either a too-small or too-big window degrades throughput. TCP-Tahoe was an early congestion control algorithm that was proposed in 1988 and later variants of it called TCP-Reno and TCP-New Reno became widely implemented in network stacks and deployed on the Internet.

Over time, a number of congestion control algorithms have been proposed that work better over internet paths with widely varying characteristics, like high bandwidth, long round-trip-time, links with higher packet loss rate, etc. BIC, CUBIC, High Speed TCP and Scalable TCP are some of the algorithms that are proposed for high speed wide area networks. TCP-Veno is optimized for wireless networks with random packet loss and TCP-Hybla aims to provide efficient data transmission over satellite links with long round-trip times.

Internet paths can have widely varying characteristics, including transmission delays, available bandwidths, congestion levels, re-ordering probabilities, supported message sizes or loss rates. Furthermore, the same internet path can have very different conditions over time. In order for the applications to operate safely under very different path conditions, conservatively probing the Internet path to establish a transmission behavior that it can sustain and that is reasonably fair to other traffic sharing the path is required. For example, the Linux kernel supports multiple Congestion Control plugins for its TCP stack and enables selection of algorithms on a system-wide as well as a per-connection basis.

### SUMMARY OF THE INVENTION

Exemplary embodiments include a TCP congestion control algorithm management method, including establishing a first TCP connection on a first network having an end-point, wherein the TCP connection includes a first TCP congestion control algorithm, monitoring path characteristics of the TCP connection and dynamically selecting and switching to a second TCP congestion control algorithm in response to a change in the path characteristics of the TCP connection, wherein the path characteristics of the TCP connection are determined when at least one of the end-point switching from the first network to a second network, the connection being active beyond a pre-determined time period, an observation that threshold values have been exceeded, and an update in at least one of an intermediate-node or a network due to at least one of a router failure and a path failure, wherein the change in the characteristic of the TCP connection includes changes in path characteristics selected from the group including but not limited to bandwidth, round-trip time, packet loss rate, path maximum transmission unit, and duplicate acknowledgements. Although each congestion control algorithm may use only a subset of these characteristics to enforce that particular algorithm, all the characteristics are monitored and taken into account to select and switch to a different congestion control algorithm.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which includes the ability to dynamically select and switch a TCP congestion control algorithm used in a TCP connection based on the changes in the path characteristics of the TCP connection. The methods, systems and computer program products described herein can be implemented in mobile or virtualization environments where an end-point of a TCP connection moves from one network to another one with totally distinct path characteristics. The methods, systems and computer program products described herein can also be implemented when the path characteristics change because of an intermediate-node or network update due to a router or path failure.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary embodiment of a system for dynamic selection and switching of TCP congestion control algorithms over a TCP connection;

FIG. 2 illustrates a TCP/IP stack in accordance with exemplary embodiments; and

FIG. 3 illustrates a flowchart of a method for dynamic selection and switching of TCP congestion control algorithms over a TCP connection in accordance with exemplary embodiments.

The detailed description explains the preferred embodiments of the invention, together with advantages and features, by way of example with reference to the drawings.

### DETAILED DESCRIPTION OF THE INVENTION

Exemplary embodiments include methods, systems and computer program products that dynamically select and switch a TCP congestion control algorithm used in a TCP connection based on the changes in the path characteristics including but not limited to bandwidth, round-trip time, packet loss rate, path maximum transmission unit (PMTU), duplicate acknowledgements (ACKs), etc. The methods, systems and computer program products described herein can be implemented in any environment where a TCP connection is established for a long time and the path characteristics change considerably over that period of time. Specifically, the methods, systems and computer program products described herein can be implemented in mobile or virtualization environments where an end-point of a TCP connection moves from one network to another one with totally distinct path characteristics. The methods, systems and computer program products described herein can also be implemented when the path characteristics change because of an intermediate-node or network update due to a router or path failure.

In exemplary embodiments, in a mobile environment, a mobile node can move from a home network to a foreign network that may be connected via a path that has characteristics totally different from the original path without losing the transport layer connections. As such, a TCP connection that is established when the node is in the home network could be using a totally different path when the node moves to a foreign network. Conventionally, TCP continues to use the same congestion control algorithm even when it moves to a different network. In exemplary embodiments, the methods, systems and computer program products described herein implements dynamic switching of the TCP congestion control algorithm when the node moves to a different type of network. For example, the mobile node could have established a connection in a home network that is attached to a gigabit Ethernet link. As such, the connection could begin with TCP-New Reno or TCP-Cubic as the congestion control algorithm. When the node moves to a foreign network that is connected via a wireless or satellite link, the system may switch to TCP-Veno or TCP-Hybla and when the node moves back to the home network, the system could switch back to the original TCP-Cubic algorithm.

Similarly, with virtualization checkpoint and restart, a virtual machine could move to a host/network with totally different path characteristics while retaining the transport layer connections. In exemplary embodiments, the systems, methods and computer program products described herein dynamically switch the TCP congestion control algorithm when a TCP connection is moved to a different host/network based on the type of the link it is attached.

The above two examples discuss switching to a different algorithm based on the change in the end-point attachment to the network. In exemplary embodiments, the methods, systems and computer program products described herein can also be implemented when a change in the path characteristics of the TCP connection beyond certain threshold values is observed.

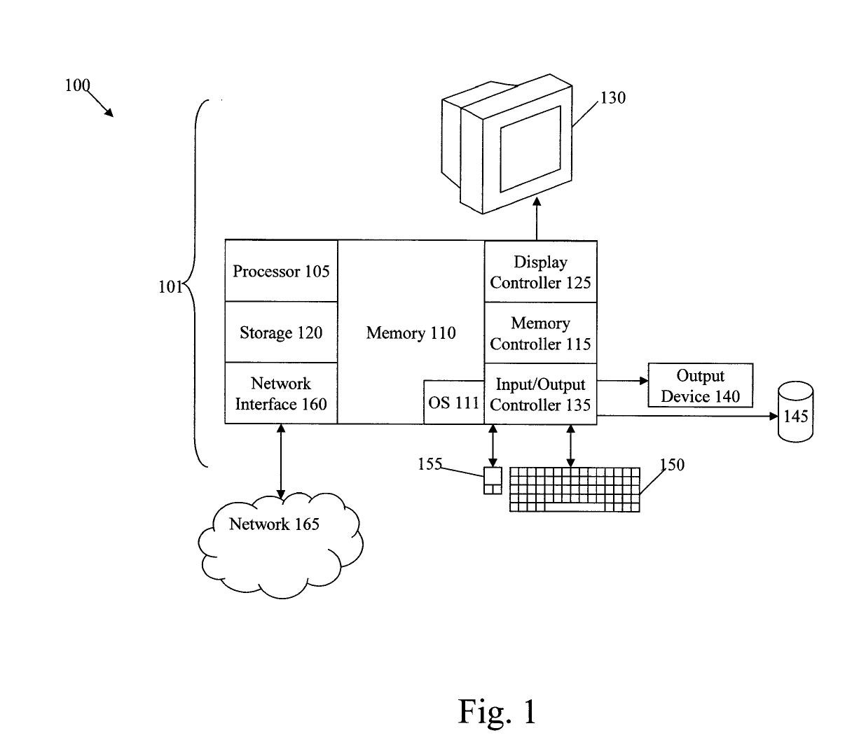

FIG. 1 illustrates an exemplary embodiment of a system 100 for dynamic selection and switching of TCP congestion control algorithms over a TCP connection. The methods described herein can be implemented in software (e.g., firmware), hardware, or a combination thereof. In exemplary embodiments, the methods described herein are implemented in software, as an executable program, and is executed by a special or general-purpose digital computer, such as a personal computer, workstation, minicomputer, or mainframe computer. The system 100 therefore includes general-purpose computer 101.

In exemplary embodiments, in terms of hardware architecture, as shown in FIG. 1, the computer 101 includes a processor 105, memory 110 coupled to a memory controller 115, and one or more input and/or output (I/O) devices 140, 145 (or peripherals) that are communicatively coupled via a local input/output controller 135. The input/output controller 135 can be, for example but not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 105 is a hardware device for executing software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing software instructions.

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another, but can be accessed by the processor 105.

The software in memory 110 may include one or more separate programs, each of which comprises an ordered listing of executable instructions for implementing logical functions. In the example of FIG. 1, the software in the memory 110 includes the dynamic TCP congestion control algorithm selection and switching methods described herein in accordance with exemplary embodiments and a suitable operating system (OS) 111. The operating system 111 essentially controls the execution of other computer programs, such as the dynamic TCP congestion control algorithm selection and switching systems and methods described herein, and provides scheduling, input-output control, file and data management, memory management, and communication control and related services.

The dynamic TCP congestion control algorithm selection and switching methods described herein may be in the form of a source program, executable program (object code), script, or any other entity comprising a set of instructions to be performed. The source program needs to be translated via a compiler, assembler, interpreter, or the like, which may or may not be included within the memory 110, so as to operate properly in connection with the OS 111. Furthermore, the dynamic TCP congestion control algorithm selection and switching methods can be written in an object oriented programming language, which has classes of data and methods, or a procedure programming language, which has routines, subroutines, and/or functions.

In exemplary embodiments, a conventional keyboard 150 and mouse 155 can be coupled to the input/output controller 135. Other output devices such as the I/O devices 140, 145 may include input devices, for example but not limited to a printer, a scanner, microphone, and the like. Finally, the I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 100 can further include a display controller 125 coupled to a display 130. In exemplary embodiments, the system 100 can further include a network interface 160 for coupling to a network 165. The network 165 can be an IP-based network for communication between the computer 101 and any external server, client and the like via a broadband connection. The network 165 transmits and receives data between the computer 101 and external systems. In exemplary embodiments, network 165 can be a managed IP network administered by a service provider. The network 165 may be implemented in a wireless fashion, e.g., using wireless protocols and technologies, such as WiFi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 101 is a PC, workstation, intelligent device or the like, the software in the memory 110 may further include a basic input output system (BIOS) (omitted for simplicity). The BIOS is a set of essential software routines that initialize and test hardware at startup, start the OS 111, and support the transfer of data among the hardware devices. The BIOS is stored in ROM so that the BIOS can be executed when the computer 101 is activated.

When the computer 101 is in operation, the processor 105 is configured to execute software stored within the memory 110, to communicate data to and from the memory 110, and to generally control operations of the computer 101 pursuant to the software. The dynamic TCP congestion algorithm selection and switching methods described herein and the OS 111, in whole or in part, but typically the latter, are read by the processor 105, perhaps buffered within the processor 105, and then executed.

When the systems and methods described herein are implemented in software, as is shown in FIG. 1, it the methods can be stored on any computer readable medium, such as storage 120, for use by or in connection with any computer related system or method. In the context of this document, a computer readable medium is an electronic, magnetic, optical, or other physical device or means that can contain or store a computer program for use by or in connection with a computer related system or method. The dynamic TCP congestion control algorithm selection and switching methods described herein can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In exemplary embodiments, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In exemplary embodiments, where the dynamic TCP congestion control algorithm selection and switching methods are implemented in hardware, the dynamic TCP congestion control algorithm selection and switching methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

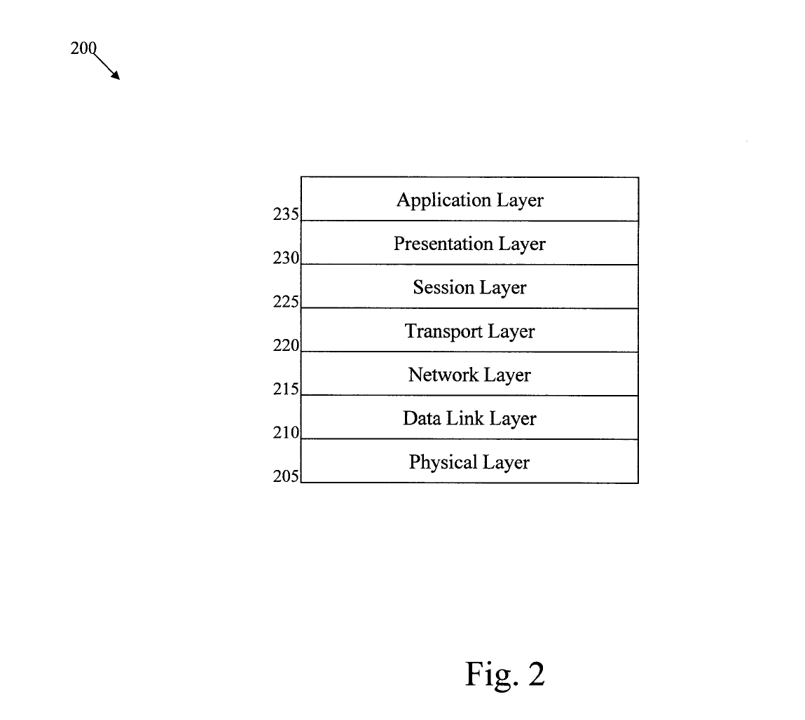

FIG. 2 illustrates a TCPIP stack 200 in accordance with exemplary embodiments. As well known in the art, the stack 200 includes a physical layer 205, a data link layer 210, a network layer 215, a transport layer 220, a session layer 225, a presentation layer 230 and an application layer 235. The physical layer 205 is the physical medium used to transmit the data. The physical layer 205 is specified by physical properties of the network connection, such as mechanical properties, electrical/optical properties, functional aspects of the data transmission (modulation/demodulation for example) and procedural aspects of data transmission (e.g. bit stuffing to ensure that special signals are unequivocal). The physical layer 205 is the realm of networking hardware specifications, and is the place where technologies reside that perform data encoding, signaling, transmission and reception functions. The physical layer 205 is closely related to the data link layer 210.

The data link layer 210 handles the transmission of a framed set of data (usually a sequence of bits) from one point in a network (node) to another one. This layer also represents the boundary between hardware (e.g. CRC) and software implementation (e.g. physical addressing). This layer is the place where most LAN and wireless LAN technologies are defined. The data link layer 210 is responsible for logical link control, media access control, hardware addressing, error detection and handling, and defining physical layer standards. The data link layer 210 is often divided into the logical link control (LLC) and media access control (MAC) sublayers, based on the IEEE 802 Project that uses that architecture.

The network layer 215 is related to the physical transmission of the data from computer to computer. The network layer 215 routes the packages across a particular network. The network layer 215 is responsible for the tasks that link together individual networks into internetworks. Network layer functions include internetwork-level addressing, routing, datagram encapsulation, fragmentation and reassembly, and certain types of error handling and diagnostics. The network layer 215 and transport layer 220 are closely related to each other.

The transport layer 220 handles the transmission, reception and error checking of the data. The transport layer 220 represents the transition point between the lower layers that deal with data delivery issues, and the higher layers that work with application software. The transport layer 220 is responsible for enabling end-to-end communication between application processes, which it accomplishes in part through the use of process-level addressing and multiplexing/demultiplexing. Transport layer protocols are responsible for dividing application data into blocks for transmission, and may be either connection-oriented or connectionless. Protocols at this layer also often provide data delivery management services such as reliability and flow control.

The session layer 225 establishes a connection with another node and manages the data flow from the higher layers to the lower ones by managing the timing of data transmission and the memory buffer managing, when several applications try to transmit data at the same time. The session layer 225 provide functions for establishing and managing sessions between software processes. Session layer technologies are often implemented as sets of software tools called application program interfaces (APIs), which provide a consistent set of services that allow programmers to develop networking applications without needing to worry about lower-level details of transport, addressing and delivery.

The presentation layer 230 includes the standards necessary for unambiguously representing data and more generally, a syntax of messages to be transmitted (simple text, executable code, pictures, etc.). Protocols at the presentation layer 230 handle manipulation tasks that transform data from one representation to another, such as translation, compression and encryption.

The application layer 235 is the totality of all applications and their relating protocols that use networks and have not yet been represented by the lower layers. Application protocols are defined at the application layer 235, which implement specific user applications and other high-level functions. Since they are at the top of the stack, application protocols are the only ones that do not provide services to a higher layer; they make use of services provided by the layers below.

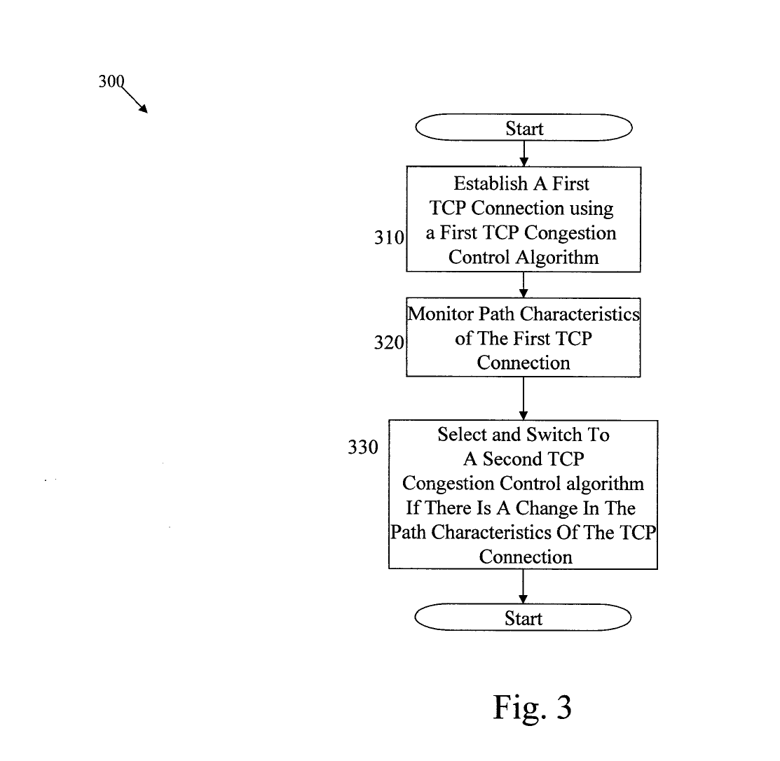

FIG. 3 illustrates a flowchart of a method 300 for dynamic selection and switching of TCP congestion control algorithms over a TCP connection in accordance with exemplary embodiments. At block 310, the system 100 first establishes a first TCP connection on a first network having an end point, wherein the TCP connection includes a first TCP congestion control algorithm. At block 320, the system 100 monitors path characteristics of the TCP connection. At block 330, the system 100 dynamically selects and switches to a second TCP congestion control algorithm in a response to a change in the path characteristics of the TCP connection. In exemplary embodiments, as described above, the change in the path characteristics of the TCP connection can include, but is not limited to, the end-point changing from the first network to a second network, the connection being active beyond a pre-determined time period, an observation that threshold values have been exceeded, and an update in at least one of an intermediate-node and a first network due to at least one of a router failure and a path failure. In exemplary embodiments, the change in the characteristic of the TCP connection can also include changes in path characteristics including, but not limited to: bandwidth, round-trip time, packet loss rate, path maximum transmission unit (PMTU), and duplicate acknowledgements (ACKs).

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A TCP congestion control algorithm management method, consisting of:
establishing a first TCP connection on a first network having an end point, wherein the TCP connection includes a first TCP congestion control algorithm;
monitoring path characteristics of the TCP connection; and
dynamically selecting and switching to a second TCP congestion control algorithm in response to a change in the path characteristics of the TCP connection,
wherein the path characteristics of the TCP connection are determined when at least one of the end-point changing from the first network to a second network, the connection being active beyond a pre-determined time period, an observation that threshold values have been exceeded, and an update in at least one of an intermediate-node and a first network due to at least one of a router failure and a path failure,
wherein the change in the characteristic of the TCP connection includes changes in connection parameters including at least one of bandwidth, round-trip time, packet loss rate, path maximum transmission unit, and duplicate acknowledgements.

2. The method as claimed in claim 1 wherein the TCP connection is a mobile environment where the end-point of the TCP connection moves from the first network with a first set of path characteristics to a second network with a second set of path characteristics.

3. The method as claimed in claim 2 wherein the endpoint is a mobile node, the first network is a home network and the second network is a foreign network including at least one of a wireless and a satellite link and the congestion control algorithms include at least one of TCP-New Reno, TCP-Cubic, TCP-Veno, TCP-Hybla, TCP-BIC, TCP-VEGAS, TCP-WESTWOOD, and TCP-HSTCP.

4. The method as claimed in claim 3 wherein the mobile node switches to a first TCP congestion control algorithm when in the home network and switches to a second TCP congestion control algorithm when in the foreign network

5. The method as claimed in claim 2 wherein the TCP connection is in a virtualization environment running in a first virtual machine and the change in the characteristic of the TCP connection occurs when the connection is checkpointed in the first virtual machine and restarted in a second virtual machine.

6. The method as claimed in claim 5 wherein a virtual machine in the virtualization environment moves to the second network that includes different path characteristics from the first network but retains transport layer connections of the first network.

7. The method as claimed in claim 1 wherein the connection uses SCTP as the transport protocol for communication between the two endpoints and the congestion control algorithms are SCTP variants of TCP congestion control algorithms.
